(19) United States
(12) Patent Application Publication
(10) Pub. No.: US 2014/0145807 A1
(43) Pub. Date: May 29, 2014

(54) MAGNETIC SHEET OF CONTACTLESS POWER TRANSMISSION DEVICE

(71) Applicant: SAMSUNG ELECTRO-MECHANICS CO., LTD., Suwon (KR)

(72) Inventors: Kang Ryong CHOI, Suwon (KR); Ji Man RYU, Suwon (KR); Dong Hyeok CHOI, Suwon (KR); Chang Ryul JUNG, Suwon (KR); Sung Yong AN, Suwon (KR)

(73) Assignee: Samsung Electro-Mechanics Co., Ltd., Suwon (KR)

(21) Appl. No.: 13/775,857

(22) Filed: Feb. 25, 2013

(30) Foreign Application Priority Data
Nov. 27, 2012 (KR) 10-2012-0135197

(51) Int. Cl. H01F 7/02

(52) U.S. Cl. CPC H01F 7/02
USPC 335/302

(57) ABSTRACT

There are provided a magnetic sheet and a contactless power transmission device including the same. The magnetic sheet includes a ferrite sheet, a metal sheet formed on the ferrite sheet and including a polymer resin and a metal powder, and an adhesive film inserted between the ferrite sheet and the metal sheet.

### CROSS-REFERENCE TO RELATED APPLICATIONS

This application claims the priority of Korean Patent Application No. 10-2012-0135197 filed on Nov. 27, 2012, in the Korean Intellectual Property Office, the disclosure of which is incorporated herein by reference.

### BACKGROUND OF THE INVENTION

1. Field of the Invention

The present invention relates to a magnetic sheet of a contactless power transmission device capable of wirelessly transmitting power using electromagnetic induction.

2. Description of the Related Art

Research into a system for contactlessly transmitting power in order to charge a secondary battery embedded in a portable terminal, or the like, with power, has been recently conducted.

A contactless power transmission device generally includes a contactless power transmitter transmitting power and a contactless power receiver receiving and storing power therein.

A contactless power transmission device transmits and receives power using electromagnetic induction. To this end, an inner portion of each of the contactless power transmitter and the contactless power receiver is provided with a coil.

A contactless power receiver configured of a circuit part and a coil part is attached to a cellular phone case or an additional accessory tool in a form of a cradle to implement a function thereof.

Describing an operational principle of the contactless power transmission device, external commercial alternating current (AC) power is input from a power supply unit of the contactless power transmitter.

The input household AC power is converted into direct current (DC) power by a power converting unit, is re-converted into an AC voltage having a specific frequency, and is then provided to the contactless power transmitter.

When the AC voltage is applied to the coil part of the contactless power transmitter, a magnetic field around the coil part is changed.

As the magnetic field of the coil part of the contactless power receiver disposed to be adjacent to the contactless power transmitter is changed, the coil part of the contactless power receiver outputs power to charge the secondary battery with power.

In the contactless power transmission device, a magnetic sheet is positioned between a radio frequency (RF) antenna and a metal battery in order to increase a communications distance.

The magnetic sheet may be a high magnetic permeability ferrite sheet used as an electromagnetic interference (EMI) countermeasure, a heat radiation countermeasure, or the like, for the contactless power transmission device. However, the ferrite sheet may have a relatively low elastic modulus, such that in a case in which an impact or mechanical stress is applied thereto, a crack or a ferrite powder drop occurs.

In the case in which the crack or the ferrite powder drop occurs in the ferrite sheet due to an impact or mechanical stress, magnetic characteristics are weakened, magnetic permeability is decreased, and EMI reduction characteristics are deteriorated.

In order to generally use the ferrite sheet in a product, the ferrite sheet should have high magnetic permeability so that it may be repeatedly adhered to or delaminated from a plane, a curved surface, or an uneven surface and does not cause a ferrite power drop.

According to the related art, a flexible ferrite substrate is manufactured by allowing the ferrite sheet to have at least one continuous U or V shaped groove before being sintered and laminating a ferrite substrate between an adhesive film and a polyethylene terephthalate (PET) film after sintering the ferrite sheet. In the case in which the contactless power transmission device is manufactured only using the ferrite sheet as described above, efficiency is lower as compared with the case of transmitting power by a wired line.

Therefore, in order to commercialize the contactless power receiver, development of a contactless power transmission device having efficiency corresponding to 70% or more of that of a wired power transmission device has been demanded.

In addition, there may be a problem in that heat generated when power is received in the contactless power receiver is transferred to a battery or an electronic apparatus.

As a result, damage due to the heat may be generated in the battery or the electronic apparatus. Therefore, a contactless power receiver capable of preventing heat generated at the time of receiving power from being transferred to a battery or an electronic apparatus has been required.

The following Related Art Document discloses an electromagnetic wave preventing sheet formed of a mixture containing ferrite and a polymer, but does not disclose a double structure of a ferrite sheet and a metal sheet as disclosed below.

### RELATED ART DOCUMENT

Korean Patent Laid-open Publication No. 2009-0034651

### SUMMARY OF THE INVENTION

An aspect of the present invention provides a magnetic sheet in which a ferrite sheet and a metal sheet including a polymer resin and a metal powder are adhered to each other by using an adhesive film in order to increase efficiency and heat radiation characteristics of a contactless power transmission device and secure flexibility of the contactless power transmission device, and a contactless power transmission device including the same.

According to an aspect of the present invention, there is provided a magnetic sheet including: a ferrite sheet; a metal sheet formed on the ferrite sheet to allow the ferrite sheet to be flexible at the time of deforming the ferrite sheet and including a polymer resin and a metal powder; and an adhesive film inserted between the ferrite sheet and the metal sheet.

The ferrite sheet may be formed of NiZnCu or MnZn.

The metal powder may include at least one selected from a group consisting of iron, aluminum, silicon, cobalt, and zinc.

The metal powder may include at least one of a sendust (Fe—Si—Al alloy)-based powder, a permalloy-based powder, and an amorphous-based powder.

The polymer resin may include at least one selected from a group consisting of chlorinated polyethylene, polypropylene, natural rubber, nitrile butadiene rubber, polyvinyl chloride, and polyimide based and polyester based resins.

A thickness of the magnetic sheet may be 0.1 to 0.5 mm.

According to another aspect of the present invention, there is provided a contactless power transmission device including: a coil part receiving an induced magnetic field generated in a contactless power transmitter to generate power; a shield part positioned on the coil part and including a magnetic sheet including a ferrite sheet, a metal sheet disposed on the ferrite sheet and including a polymer resin and a metal powder, and an adhesive film inserted between the ferrite sheet and the metal sheet; and a power output part outputting the power generated in the coil part and positioned on the shield part.

The power output part may include a rechargeable secondary battery.

The ferrite sheet may be formed of NiZnCu or MnZn.

The metal powder may include at least one selected from a group consisting of iron, aluminum, silicon, cobalt, and zinc.

The metal powder may be at least one of a sendust (Fe—Si—Al alloy)-based powder, a permalloy-based powder, and an amorphous-based powder.

The polymer resin may include at least one selected from a group consisting of chlorinated polyethylene, polypropylene, natural rubber, nitrile butadiene rubber, polyvinyl chloride, and polyimide based and polyester based resins.

A thickness of the magnetic sheet may be 0.1 to 0.5 mm.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a magnetic sheet according to an embodiment of the present invention;

FIG. 2 is a cross-sectional view of the magnetic sheet of FIG. 1;

FIG. 3 is an exploded perspective view schematically showing a contactless power transmission device according to another embodiment of the present invention;

FIG. 4 is a cross-sectional view of the contactless power transmission device of FIG. 3; and

FIG. 5 is a flowchart showing a process of manufacturing a magnetic sheet according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

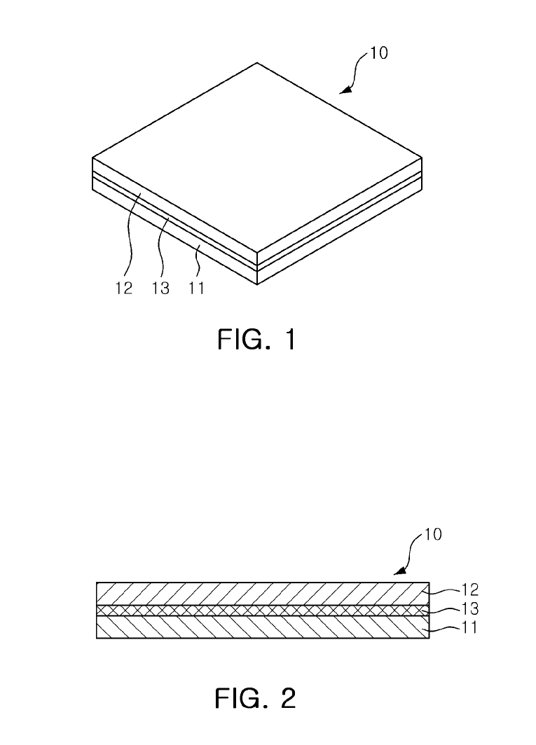

FIG. 1 is a perspective view schematically showing a magnetic sheet 10 according to an embodiment of the present invention, and FIG. 2 is a cross-sectional view of the magnetic sheet 10 of FIG. 1.

Referring to FIGS. 1 and 2, the magnetic sheet 10 according to the present embodiment may include a ferrite sheet 11, a metal sheet 12, and an adhesive film 13 adhering the ferrite sheet 11 and the metal sheet 12 to each other.

A material of the ferrite sheet 11 may be a ferrite soft magnetic material, for example, NiZnCu or MnZn, but is not limited thereto.

The metal sheet 12 may include a polymer resin and a metal powder.

The metal powder of the metal sheet 12 may be at least one selected from a group consisting of iron, aluminum, silicon, cobalt, and zinc, but is not limited thereto.

In addition, the metal powder of the metal sheet 12 may be at least one of a sendust (Fe—Si—Al alloy)-based powder, a permalloy-based powder, and an amorphous-based powder, but is not limited thereto.

The metal powder included in the metal sheet 12 may be a material capable of receiving a signal in a frequency band different from that of the ferrite sheet 11. In this case, the metal powder included in the metal sheet 12 may simultaneously enable contactless power transmission and near field communications (NFC).

The polymer resin included in the metal sheet 12 may be at least one selected from a group consisting of chlorinated polyethylene, polypropylene, natural rubber, nitrile butadiene rubber, polyvinyl chloride, and polyimide based and polyester based resins, but is not limited thereto.

The polymer resin included in the metal sheet 12 may serve to diffuse heat that may be directed toward a battery or an electronic apparatus at the time of charging, to the periphery and serve to improve heat radiation characteristics of the metal sheet 12.

In addition, the polymer resin included in the metal sheet 12 may serve to decrease hardness of the ferrite sheet 11 to improve flexibility of the magnetic sheet 10.

The adhesive sheet 13 may serve to adhere the ferrite sheet 11 and the metal sheet 12 to each other so as not to be separated from each other and provide a heat path discharging the heat generated at the time of contactless power transmission.

The adhesive sheet 13 may be formed of a material having relatively good thermal conductivity, for example, epoxy, but is not limited thereto.

The number of each of the ferrite sheet 11 and the metal sheet 12 of the magnetic sheet 10 may be at least one.

A thickness of the magnetic sheet 10 may be 0.1 to 0.5 mm.

In the case in which the thickness of the magnetic sheet 10 is 0.1 mm or more, efficiency of a contactless power transmission device may be significantly increased, and in the case in which the thickness of the magnetic sheet 10 is 0.5 mm or less, the magnetic sheet 10 may secure a commercialization property as a component of the contactless power transmission device.

The following Table 1 shows efficiency of the contactless power transmission device according to a thickness of the magnetic sheet.

TABLE 1

| Thickness (mm) | Efficiency (%) |
|---|---|
| 0.04 | 5% |
| 0.09 | 9.5% |
| 0.1 | 52.3% |
| 0.2 | 62.5% |
| 0.3 | 68.9% |
| 0.4 | 70.2% |
| 0.5 | 70.8% |
| 0.51 | 72.3% |
| 0.6 | 74.0% |

As seen in the above Table 1, in the case in which the thickness of the magnetic sheet 10 is less than 0.1 mm, the efficiency of the contactless power transmission device may be significantly decreased, and in the case in which the thickness of the magnetic sheet 10 exceeds 0.5 mm, the entire thickness of the contactless power transmission device may become thick, such that a commercialization property is decreased.

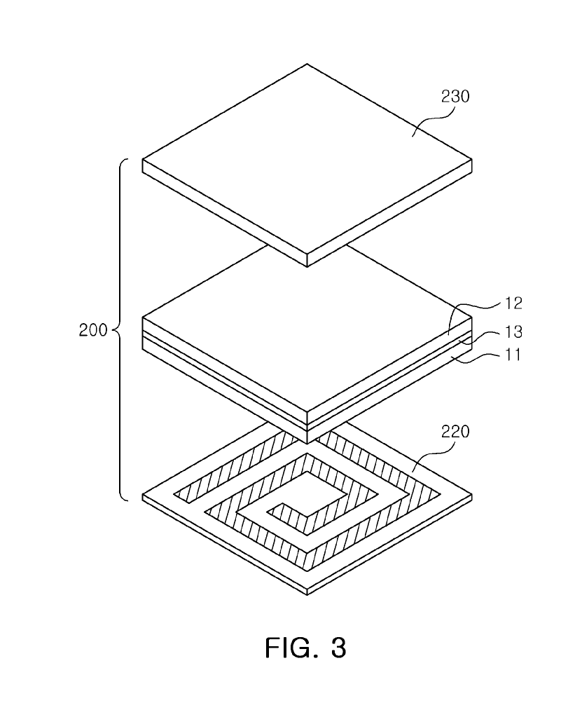

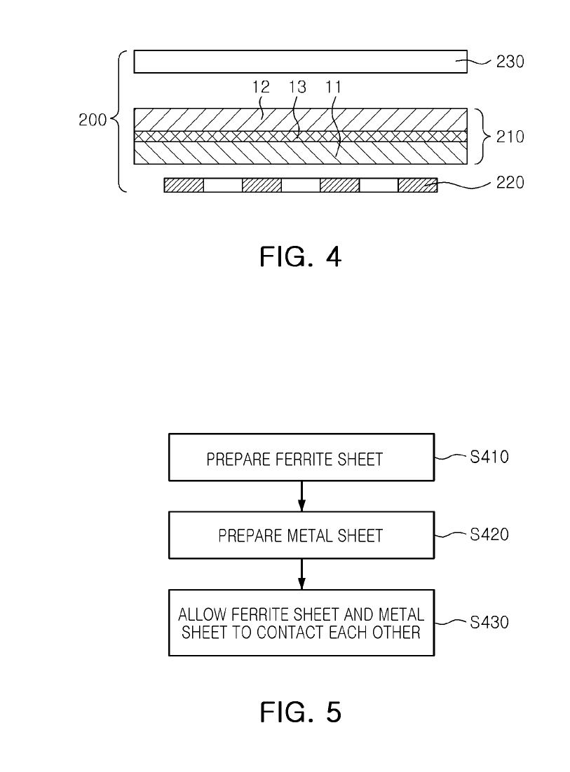

FIG. 3 is an exploded perspective view schematically showing a contactless power transmission device according to another embodiment of the present invention, and FIG. 4 is a cross-sectional view of the contactless power transmission device of FIG. 3.

Referring to FIGS. 3 and 4, the contactless power transmission device according to another embodiment of the present invention may include a coil part 220 receiving an induced magnetic field generated in a contactless power transmitter to generate power; a shield part 210 positioned on the coil part 220 and including a magnetic sheet 10 including a ferrite sheet 11, a metal sheet 12 including a polymer resin and a metal powder, and an adhesive film 13 inserted between the ferrite sheet and the metal sheet; and a power output part 230 outputting the power generated in the coil part 220 and positioned on the shield part.

The power output part 230 may include a rechargeable secondary battery, for example, a lithium ion secondary battery, but is not limited thereto.

The coil part 220 may include a single coil formed in a wiring pattern form or a single coil pattern formed by connecting a plurality of coil strands in parallel with one another.

The coil part 220 may include a magnetic path formed therein.

The coil part 220 may be manufactured in a winding form or be manufactured in a flexible film form, but is not limited thereto.

The coil part 220 transmits input power by using an induced magnetic field or receives the induced magnetic field to allow the power to be output, thereby enabling contactless power transmission.

The shield part 210 may serve to receive the magnetic field generated in the coil part 220 to increase inductance of the coil part 220.

In addition, the shield part 210 may serve to enable power transmission even in a case in which a transmitter and a receiver of the contactless power transmission device are spaced apart from each other by a predetermined distance.

FIG. 5 is a flowchart showing a process of manufacturing a magnetic sheet 10 according to the embodiment of the present invention.

Referring to FIG. 5, the process of manufacturing a magnetic sheet may include preparing a ferrite sheet 11 using a mixture generated by mixing a ferrite powder and a binder (S410); preparing a metal sheet 12 separately from the ferrite sheet by mixing a polymer resin and a metal powder with each other (S420); and laminating the ferrite sheet 11 and the metal sheet 12 using an adhesive film 13 (S430).

The following Table 2 shows Experimental Examples of connecting a secondary battery to the power output part 230 of the contactless power transmission device 200, charging the secondary battery with power by using the contactless power transmission device, and then measuring charging efficiency.

TABLE 2

| | Voltage | Current | Efficiency |
|---|---|---|---|
| Inventive | 19 | 0.259 | 71% |
| Example 1 | | | |
| Inventive | 19 | 0.262 | 70% |
| Example 2 | | | |
| Comparative | 19 | 0.272 | 67% |
| Example 1 | | | |
| Comparative | 19 | 0.266 | 69% |
| Example 2 | | | |
| Comparative | 19 | 0.266 | 69% |
| Example 3 | | | |
| Comparative | 19 | 0.272 | 67% |
| Example 4 | | | |

A result of comparing efficiency of the contactless power transmission device using the magnetic sheet manufactured according to the embodiment of the present invention with that of a wired power transmission device is shown in the above Table 2.

Inventive Examples 1 and 2 are examples of a contactless power transmission device using the magnetic sheet according to the embodiment of the present invention.

Comparative Examples 1 and 2 are examples of a contactless power transmission device including a magnetic sheet formed only of a metal.

Comparative Examples 3 and 4 are examples of a contactless power transmission device including a magnetic sheet formed only of ferrite.

It may be appreciated from the above Table 2 that the contactless power transmission device using the magnetic sheet according to the embodiment of the present invention has efficiency of 70% or more, which is higher than that of the contactless power transmission device including the magnetic sheet formed only of a metal (Comparative Examples 1 and 2) or the contactless power transmission device including the magnetic sheet formed only of ferrite (Comparative Examples 3 and 4).

The magnetic sheet and the contactless power transmission device including the same according to the embodiment of the present invention described above are not limited to the above-mentioned embodiments, but may be variously applied.

For example, although the case in which one surface of the ferrite sheet 11 of the magnetic sheet 10 contact the coil part 220 has been shown in FIGS. 3 and 4, unlike this, one surface of the metal sheet 12 may contact the coil part 220.

Further, although only the contactless power transmitter has been shown in FIGS. 3 and 4, the magnetic sheet 10 according to the embodiment of the present invention may also be applied to a contactless power receiver.

In addition, although the contactless power transmission device has been described in the above-mentioned embodiments by way of example, the contactless power transmission device according to the embodiment of the present invention is not limited thereto, but may be widely used in all electronic apparatuses capable of being used by charging power therein and all power transmission devices capable of transmitting the power.

As set forth above, according to the embodiments of the present invention, since the ferrite sheet and the metal sheet configuring the magnetic sheet have different available frequency ranges, the contactless power transmission and the near field communications (NFC) may be simultaneously performed.

In addition, the polymer component of the metal sheet diffuses the heat that may be generated at the time of charging to the periphery, whereby a heat generation problem may be decreased.

Further, the metal sheet formed of the polymer resin and the metal powder decreases the hardness of the ferrite sheet, whereby the flexibility of the magnetic sheet may be improved.

While the present invention has been shown and described in connection with the embodiments, it will be apparent to those skilled in the art that modifications and variations can be made without departing from the spirit and scope of the invention as defined by the appended claims.

What is claimed is:

1. A magnetic sheet comprising:
a ferrite sheet;
a metal sheet disposed on the ferrite sheet to allow the ferrite sheet to be flexible at the time of deforming the ferrite sheet and including a polymer resin and a metal powder; and
an adhesive film inserted between the ferrite sheet and the metal sheet.

2. The magnetic sheet of claim 1, wherein the ferrite sheet is formed of NiZnCu or MnZn.

3. The magnetic sheet of claim 1, wherein the metal powder includes at least one selected from a group consisting of iron, aluminum, silicon, cobalt, and zinc.

4. The magnetic sheet of claim 1, wherein the metal powder includes at least one of a sendust (Fe—Si—Al alloy)-based powder, a permalloy-based powder, and an amorphous-based powder.

5. The magnetic sheet of claim 1, wherein the polymer resin includes at least one selected from a group consisting of chlorinated polyethylene, polypropylene, natural rubber, nitrile butadiene rubber, polyvinyl chloride, and polyimide based and polyester based resins.

6. The magnetic sheet of claim 1, wherein a thickness of the magnetic sheet is 0.1 to 0.5 mm.

7. A contactless power transmission device comprising:
a coil part receiving an induced magnetic field generated in a contactless power transmitter to generate power;
a shield part positioned on the coil part and including a magnetic sheet including a ferrite sheet, a metal sheet disposed on the ferrite sheet and including a polymer resin and a metal powder, and an adhesive film inserted between the ferrite sheet and the metal sheet; and
a power output part outputting the power generated in the coil part and positioned on the shield part.

8. The contactless power transmission device of claim 7, wherein the power output part includes a rechargeable secondary battery.

9. The contactless power transmission device of claim 7, wherein the ferrite sheet is formed of NiZnCu or MnZn.

10. The contactless power transmission device of claim 7, wherein the metal powder includes at least one selected from a group consisting of iron, aluminum, silicon, cobalt, and zinc.

11. The contactless power transmission device of claim 7, wherein the metal powder is at least one of a sendust (Fe—Si—Al alloy)-based powder, a permalloy-based powder, and an amorphous-based powder.

12. The contactless power transmission device of claim 7, wherein the polymer resin includes at least one selected from a group consisting of chlorinated polyethylene, polypropylene, natural rubber, nitrile butadiene rubber, polyvinyl chloride, and polyimide based and polyester based resins.

13. The contactless power transmission device of claim 7, wherein a thickness of the magnetic sheet is 0.1 to 0.5 mm.
